(19) United States
(12) Patent Application Publication
(10) Pub. No.: US 2012/0141216 A1
(43) Pub. Date: Jun. 7, 2012

(54) SCREW CONNECTIONS ON CUTTING TOOLS

(76) Inventor: Wolfgang Zitzlaff, Kirchheim/Teck (DE)

(21) Appl. No.: 13/264,781

(22) PCT Filed: Apr. 20, 2010
(86) PCT No.: PCT/EP2010/055197

§ 371 Date: Nov. 3, 2011

(30) Foreign Application Priority Data
Apr. 21, 2009 (DE) 10 2009 002 535.9

(51) Int. Cl. B23B 27/16; F16B 35/04; C10M 169/04; F16B 7/18

(52) U.S. Cl. 407/107; 407/102; 403/343; 411/411; 508/154

(57) ABSTRACT

A screw connection to be undone without problems and without disproportionate application of force after long-term use in cutting under extreme usage conditions with dirt, extreme heat, moisture, oxidation and alternating loads provides that the screws have a smooth surface due to coating at least in the area of the thread of the screws, that PTFE particles, preferably have a particle size between 100 nm and 300 nm, are continued in the coating, and the screw connection of the two thread partners are lubricated using small amounts of a heat-resistant grease having ceramic powder particles.

The invention describes an improvement of certain properties of screw connections having screws and associated threaded holes on cutting tools which are used for cutting primarily metallic materials.

DE 10 2008 001 857 A1 describes a cutting tool for accommodating cutting inserts for machining metallic workpieces, having a receptacle designed as an insert seat and having insert seat walls and an insert seat base for accommodating the cutting insert, the cutting insert having side faces which in the mounted state of the cutting insert are situated on the cutting tool, parallel to the insert seat walls, and the cutting insert being fastened in the insert seat by clamping means. A cutting body support is fastened on the insert seat base by means of a screw. To increase the service life of the cutting tool, it is proposed that an exchangeable fitting piece is situated between an insert seat wall and a side face of the cutting insert. In one embodiment, this fitting piece is fastened to the cutting tool by screws. The clamping means for the cutting insert in the insert seat include a clamping claw which is fastened to the cutting tool by means of a fastening screw. Thus, different screw connections are used on cutting tools.

The most important screw connection on cutting tools is the fastening screw of the clamping claw which clamps the cutting insert, cutting body, or cutting plate. For cutting cast iron materials, for example, without the use of cooling lubricants, during the material removal considerable heat is generated which is not completely dissipated via the chips, but, rather, is also dissipated via the cutting body into the tool holder of the cutting tool and into the clamping claw and other clamping means. After an extended operating period, the components heat up greatly, the lubricating greases become soft and possibly evaporate, and the lubricating effect decreases. In addition, casting dust and chips are absorbed by the liquid grease. The overall connection becomes soiled over time, and ultimately tends to become gummy and sticky. Furthermore, after a certain cutting time the cutting body must be replaced, which is performed by loosening the screw connection of the clamping claw, exchanging or turning the cutting body, and retightening the screw connection. It is usually unavoidable that dirt by necessity also enters into the screw connection. As a result, the functionality of the screw connection decreases or completely ceases over time.

The object of the invention is to improve the screw connections in such a way that the connection may be easily loosened without disproportionate application of force after long-term use in cutting under extreme conditions of use with dirt, extreme heat, moisture, oxidation, and alternating loads.

According to the invention, this object is achieved by the features of claim 1.

This object is achieved by the combination and use according to the invention of coated, preferably chemically nickel-plated, screws, and by the fact that the screw connection, i.e., the two thread partners (screws and threaded holes), is/are lubricated with small amounts of a heat-resistant grease containing ceramic powder particles. To achieve corrosion resistance and dry lubrication properties, the screws that are used are preferably chemically nickel-plated, and as a special feature polytetrafluoroethylene (PTFE) particles are additionally embedded in the coating, for example in the nickel layer. PTFE is a fully fluorinated polymer which is generally known under the product name Teflon from DuPont.

The embedding of PTFE particles has the advantage that, in contrast to applied lubricants, the low coefficient of friction of approximately 0.1 is maintained over the entire nickel layer due to the very homogeneously embedded PTFE particles. Even in the event of microscopically small abrasion, new PTFE particles continuously arrive at the surface, thus ensuring the lubricating properties over the entire service life of the layer.

This coating with nickel with embedding of PTFE particles is also referred to as a nickel-PTFE dispersion layer, which has 20-30 vol-% superfine PTFE embedded in the nickel matrix.

Due to the low coefficients of friction, the aid provided by a heat-resistant grease containing nontoxic ceramic powder components as emergency running properties also optimizes this screw connection, and, in addition to the ease of loosening, also provides a dirt-repellent property which increases the service life and ease of installation of the screw connection. This results in high reliability of the components used, and therefore, customer satisfaction.

The use of screws which are chemically burnished or made corrosion-resistant using other methods is part of the prior art. The chemical nickel plating of screws, threaded pins, and other structural components constitutes prior art which is known per se, but whose use on cutting tool holders or on cutting tools is not known. The use of screws in which PTFE particles are additionally embedded in the nickel layer is likewise not known for cutting tool holders. For corrosion resistance, the method according to the invention provides even better sliding properties of the mechanical connections.

The prior art for screw connections on cutting tools also includes the use of heat-resistant greases which are designed to provide emergency lubricating properties as the result of embedding typically copper particles. These copper-containing greases are very heat-resistant. The copper particles provide emergency lubricating properties which result when the lubricating property of the grease in the screw connection decreases or ceases due to high operating temperatures of 100° to 400°. These greases are used in automobiles, for example, to maintain functionality of the brake lining in disc brake systems.

The use of chemically nickel-plated components with embedded PTFE particles in combination with a highly heat-resistant grease containing microfine ceramic particles, and the preferred use of this grease in screw connections, in particular for clamping claws on cutting tools, is novel in its mode of operation. This grease is used for the targeted and controlled avoidance of the friction forces between the individual components, and in the screw connection in particular. This material-lubricant combination is characterized by the superior sliding properties and the emergency lubricating properties which last over long-term use. In addition, due to the smooth surface of the coating as well as the dirt- and moisture-repellent properties of the grease, the absorption of dirt and chips as well as gumming of the components are prevented. Lastly, failure of the functional properties of the screw connection, even under harsh conditions of use, is avoidable. The service life of this dynamic screw connection, which is also under the influence of cutting forces, heat, and vibrations, is increased. The replacement cycles may be prolonged, and the maintenance effort is minimized. This results in reduced costs due to the decreased need for components which must be replaced prematurely. An additional advantage is the [reduced] environmental impact due to less use of lubricants.

The invention is described in greater detail below with reference to the features of the claims.

According to the invention, a screw connection having screws and associated threaded holes on cutting tools is improved in that the screws have a smooth surface due to coating at least in the area of their thread, that PTFE particles, preferably having a particle size between 100 nm and 300 nm, are contained in the coating, and that the screw connection, i.e., the two thread partners (screws and threaded holes), is/are lubricated with small amounts of a heat-resistant grease containing ceramic powder particles. As a result of the smooth coating, the screw connection is [easily] loosened, even after a long period of use. The PTFE particles ensure the lubricating properties over the entire service life of the layer. By use of these measures, the screw connection may be provided with a reduced amount of lubricant.

The thickness of the coating is less than 25 μm, preferably less than 10 μm, and particularly preferably is between 3 μm and 7 μm. The coefficients of sliding friction of the screws in the coated region are preferably between 0.05 and 0.07.

The PTFE particles constitute between 20 and 30 percent by volume, preferably 25 percent by volume, of the coating. As a result, the lubricating properties and the loosening capability of the screw connection have an optimal relationship to one another.

In one preferred embodiment, the smooth surface of the screws is produced by chemical nickel plating with simultaneous incorporation of PTFE particles into the nickel layer. The result is a single dispersion layer which combines the hardness of the nickel and the sliding properties of the PTFE. A nickel-PTFE dispersion layer containing approximately 25 vol.-% embedded PTFE superfine particles in the nickel matrix is part of the prior art.

In one embodiment, the coating contains phosphorus, preferably 1 percent by weight phosphorus.

According to the invention, the screw connections, i.e., the two thread partners (screws and threaded holes), are lubricated with small amounts of a grease containing ceramic particles.

A method for improving the screw connections having screws and associated threaded holes on cutting tools is characterized in that the screws are coated at least in the area of their thread in order to obtain a smooth surface, that PTFE particles, preferably having a particle size between 100 nm and 300 nm, are incorporated into the coating, and that the screw connection, i.e., the two thread partners (screws and threaded holes), is/are lubricated with small amounts of a heat-resistant grease containing ceramic powder particles.

In one special embodiment, for the coating, the screws that are used for the coating are chemically nickel-plated with simultaneous incorporation of PTFE particles into the nickel layer, and the thread partners of the screw connections are lubricated with a heat-resistant grease containing ceramic powder components.

The use of screws which are coated at least in the threaded area and which contain PTFE particles in the coating is preferred in screw connections on cutting tools.

In the use, it is preferred that chemically nickel-plated screws are used which contain PTFE particles in the nickel layer.

Heat-resistant grease containing ceramic powder components is advantageously used for lubricating the screw connections.

A cutting tool according to the invention, having components which are fastened by means of screw connections and having lubrication of the thread partners of these screw connections by use of a grease, is characterized in that the screws of the screw connections are coated, and contain embedded PTFE particles in the coating, and that the thread partners of the screw connections are lubricated with a heat-resistant grease containing ceramic powder components.

For the coating, the screws of the screw connections are preferably chemically nickel-plated and contain embedded PTFE particles in the nickel layer.

Screws according to the invention for fastening components to cutting tools are characterized in that the screws are coated with simultaneous incorporation of PTFE particles into the coating.

In one preferred embodiment, the screws are chemically nickel-plated with simultaneous incorporation of PTFE particles into the nickel layer.

A grease according to the invention for lubricating screw connections on cutting tools is characterized in that the grease is heat-resistant and is provided with ceramic powder components.

The screw connections according to the invention, the method according to the invention for improving the screw connections, the use according to the invention, the cutting tool according to the invention, the screws according to the invention, and the grease according to the invention are characterized in that the screw connections include the clamping claw screw connections, the support plate fastenings, the cutting body adapter fastening, or cartridge and parting-off blade fastenings.

The invention is explained in greater detail below with reference to one exemplary embodiment in various figures as views and sections.

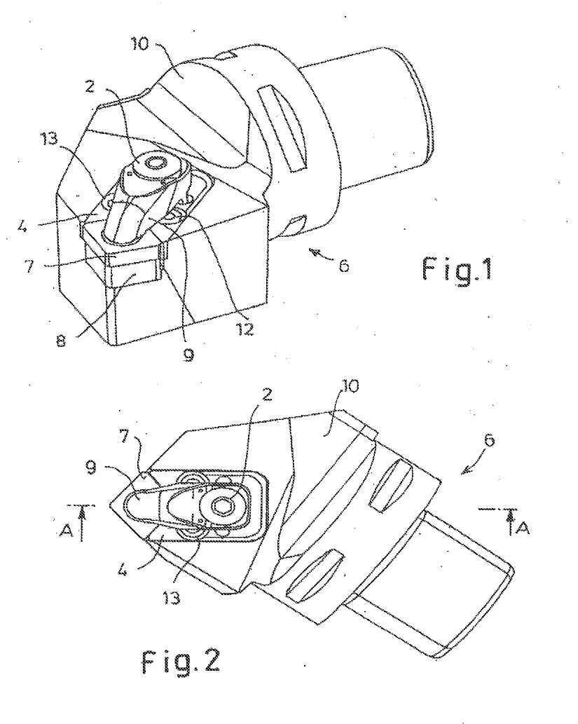

FIGS. 1, 2, 3, 4 show a cutting tool 6 according to the invention having a cutting body adapter 4 mounted thereon, in which a cutting body 7 (in the present case, an indexable insert) is used on a support plate 8. The fastening is achieved by means of a clamping claw 9. The clamping claw is fastened on the cutting tool 6, i.e., the tool holder 10, by means of a screw 2. This clamping claw screw connection is denoted by reference numeral 11 in the figures. The support plate 8 is also fastened on the cutting tool 6, i.e., the tool holder 10, by means of a screw 2. This support plate fastening is denoted by reference numeral 12 in the figures.

The cutting body adapter 4 is exchangeable, and is accommodated, held, and guided in a pocket or recess, suitable for this purpose, on the tool holder 10. This cutting body adapter fastening is denoted by reference numeral 13 in the figures. For this purpose, boreholes are introduced in the cutting body adapter 4 through which screws 2 are guided. These screws are screwed into threaded holes in the base on which the cutting body adapter 4 rests. The shape and orientation of the exterior of the cutting body adapter 4 are adapted to the side walls of the pocket on the tool holder 10. The interior form of the adapter 1 [sic; 4] is once again a pocket or recess whose shape and orientation are such as required by the cutting body 7, i.e., the indexable insert, to be used. This pocket or recess is practically identical to the pockets or recesses on standard tool holders, except for this cutting body adapter, which is located between the cutting body 7 and the tool holder 10. The cutting body 7 is embedded at three mutually angled walls or surfaces, and thus no longer has direct contact with the tool holder 10.

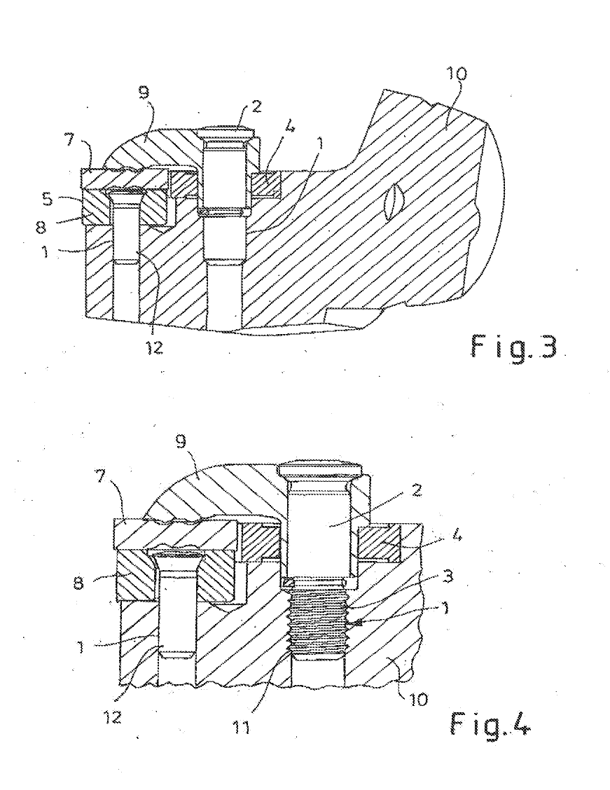

As shown in FIGS. 3 and 4, a trough is introduced into the cutting body 7, also referred to as a cutting insert or indexable insert, as described in WO 03/013770 A1. The trough has a circular design, and has a spherical or circular elevation in the center. The peak of the elevation is situated above the base of the trough and below the top side of the cutting insert. For clamping on the tool holder, a clamping claw 9 as fastening means engages with its nose, which is adapted to the trough, with the trough in the cutting body 7 in a positive-fit manner. This trough is used for positive-fit tensioning on the tool holder. This cutting body 7 having the special trough is suited in particular for drawing cuts, in which the cutting body 7 could be pulled from its seat due to the cutting forces which act. A further description of this trough is provided in the cited document.

Threaded holes are introduced into the base, on which the cutting body adapter rests, for fastening the cutting body adapter 4 in the pocket of the tool holder 10 by means of screws.

To prevent lapping or grinding machining operations on the top sides of the cutting body from influencing the clamping properties of the cutting body 7, in one embodiment the trough is designed as described in EP 1 536 903 B1. In this case, a first clamping trough for the clamping is introduced into the cutting tool, and a second clamping trough is oriented coaxially with respect to the first clamping trough, the first clamping trough being deeper than the second clamping trough, and both clamping troughs being situated more deeply than the top side of the cutting insert. When the cutting body 7 is clamped, the clamping claw 9 rests on the second clamping trough, and the nose of the clamping claw engages with the first clamping trough. The distance from the supporting surface of the clamping claw 9 to the trough is therefore always constant, and does not depend on lapping or grinding machining operations on the top sides of the cutting insert.

In one embodiment the cutting body 7 is made of PCBN or CBN, as described in WO 2005/021192 A1 The clamping trough may once again have a circular design and may have a spherical or circular elevation in the center, as described above. The corresponding contour of the clamping trough is preferably introduced by laser processing or by appropriate shaping of the base body, and the base body thus produced is then dried and sintered.

According to the invention, the screws 2 have a smooth surface due to coating at least in the area of their thread 3, and the screw connection, i.e., the two thread partners (screws and threaded holes), is/are lubricated with small amounts of a heat-resistant grease containing ceramic powder particles.

These screw connections 1 include, for example, the clamping claw screw connections 11 (see FIG. 4), the support plate fastenings 12 (see FIGS. 3 and 4), the cutting body adapter fastenings 13 (see FIGS. 1 and 2), or cartridge and parting-off blade fastenings.

1-17. (canceled)

18. A screw connection having a screw and an associated threaded hole on a cutting tool, wherein the screw has a smooth surface that is coated in at least the area of thread, wherein the coating comprises PTFE particles, and the screw connection is lubricated with a heat-resistant grease comprising ceramic powder particles.

19. A screw connection according to claim 18, wherein the thickness of the coating is less than 25 μm.

20. A screw connection according to claim 18, wherein a coefficient of sliding friction of the screw in the coated region is between 0.05 and 0.07.

21. A screw connection according to claim 18, wherein the PTFE particles constitute between 20 and 30 percent by volume of the coating.

22. A screw connection according to claim 18, wherein the smooth surface of the screw is produced by chemical nickel plating with simultaneous incorporation of PTFE particles into the nickel layer.

23. A screw connection according to claim 18, wherein the coating contains phosphorus.

24. A method for improving a screw connection having a screw with a thread and an associated threaded hole on a cutting tool, comprising coating the screw in at least in the area of the thread in order to obtain a smooth surface, wherein PTFE particles are incorporated into the coating, and wherein the screw connection is lubricated with small amounts of a heat-resistant grease containing ceramic powder particles.

25. A method according to claim 24, wherein the screw is chemically nickel-plated with simultaneous incorporation of PTFE particles into the nickel layer.

26. A cutting tool comprising a screw connection coated at least in the threaded area and which contain PTFE particles in the coating, in screw connections on a cutting tool, wherein the screw connection forms at least a portion of a clamping claw.

27. A cutting tool according to claim 26, wherein the chemically nickel-plated screw contains PTFE particles in the nickel layer.

28. A cutting tool according to claim 26, wherein heat-resistant grease containing a ceramic powder lubricates the screw connection.

29. A cutting tool comprising a cutting element, a screw connection comprising a screw and a hole for receiving said screw, wherein the screw is threaded and the hole has receiving threads for receiving the threads of the screw, wherein said screw connection is lubricated on the threads of the screw and the receiving threads of a corresponding hole for receiving the screw with grease, wherein the screw is coated with a coating that comprises PTFE particles, wherein the thread partners of the screw connection is lubricated with a heat-resistant grease containing ceramic powder components.

30. A cutting tool according to claim 18, wherein for the coating, the screws of the screw connections are chemically nickel-plated and contain embedded PTFE particles in the nickel layer.

31. A screw coated with a coating having PTFE particles incorporated therein.

32. A screw according to claim 31, wherein the screw is chemically nickel-plated and PTFE particles are incorporated into the nickel layer.

33. A grease for lubricating screw connections on cutting tools, wherein the grease is heat-resistant and is provided with ceramic powder components.

34. A cutting tool comprising the screw connection of claim 18, wherein the screw connections is a clamping claw screw connection, a support plate fastening, a cutting body adapter fastening, or a cartridge and parting-off blade fastening.

35. A cutting tool according to claim 34, wherein the thickness of the coating is less than 10 μm.

36. A cutting tool according to claim 34, wherein the thickness of the coating is between 3 μm and 7 μm.
